(19) United States
(12) Patent Application Publication
(10) Pub. No.: US 2003/0079965 A1
(43) Pub. Date: May 1, 2003

(54) Conveyor apparatus for sugar mill intermediates

(76) Inventor: Juan Manuel Moreno, Cali (CO)

Correspondence Address: Robert M. Jackson, Esq., Bush Intellectual Property Law Group, LLC, P.O. Box 381146, Birmingham, AL, 35238, US

(21) Appl. No.: 10/272,608

(22) Filed: Oct. 16, 2002

(30) Foreign Application Priority Data
Oct. 16, 2001 (CO) 01 88604

(51) Int. Cl. B65G 15/42

(52) U.S. Cl. 198/690.2

(57) ABSTRACT

A conveyor apparatus for sugar mill intermediates of the present invention comprises an infinite-loop rubber belt, a drive drum located toward the upper part of the belt consisting of a rubber lined cylinder and a central axle connected to a moto-reducer that allows it to move. On the opposite or lower end there is a feed drum with a central axle and a runner system that allows the belt to be tightened and loosened. The drive drum is mounted on pedestal-type bearings and the feed drum on flange-type bearings. The belt slides over a stainless steel tray located between the two drums. The conveyor has side or lateral walls fixed using angles with screws. It has two covers, an upper cover for the drive drum and a lower cover for the fed drum, and it also has a spill duct. A conveyor apparatus of the present invention may further comprise an infinite-loop belt comprised of four pieces of high-resistance canvas, and has a series of wings that act as pushers, which are vulcanized to the belt with an internal guide to work with the drive drums. A conveyor apparatus of the present invention may still further comprise a stainless steel tray located between the two drums consists of a rectangular chassis with reinforced fixing structures on each of the vertices of its ends and there is a stainless steel plate on the upper part of the chassis covering the surface that encloses its area.

### FIELD OF THE INVENTION

The present invention relates to an apparatus for conveying sugar mill intermediates that allows bagasse to be transported from one mill to the next, and more specifically, a conveyor apparatus comprising a conveyor belt, a stainless steel tray located between two drums, one being the drive drum and the other being the feed drum, on which the conveyor belt, which slides over the aforementioned tray, is mounted.

### BACKGROUND OF THE INVENTION

In the sugar industry there are chain conveyors that allow the bagasse exiting a mill to enter the next one, allowing in this step the cane to receive the maceration juice. Chain conveyors achieve traction using chains with attachments and slats, with operating angles that should not be greater than 50°, 11.6 cm drive axles and 8.9 cm feed axles, and an operating speed of 39.6 m/minute. This type of conveyor requires constant monitoring of bearings, chains, gear wheels and slats, changing elements such as pins, links, runners and tables. There is a significant tendency of these conventional chain conveyors to derail. Further, their disassembly and maintenance is laborious, which translates into significant lost time and increased costs.

The present invention's conveyor belt or belt drive is an excellent solution for the problems inherent to conventional belts or drives. The present invention results in annual savings in maintenance, a reduction in lost operating time due to the ease of disassembly and therefore in maintenance, which for the present invention basically requires only review and greasing of bearings given that there are no elements that must be changed frequently.

One of the biggest advantages of the conveyor apparatus of the present invention is its resistance to corrosion, which occurs due to the pH present in the crude which varies between 4.5 and 5 pH. This attacks the chains of conventional conveyors causing wear by corrosion; however, the belts of the conveyor apparatus of the present invention are not affected by this. Furthermore the load is carried on the belt, which unlike traditional conveyors does not lead to any type of wear. With respect to speed, traditional conveyors work at high speeds, up to 100.6 m/min, due to which the precise load on the conveyor at a specific times is minimum. This leads to lower power consumption of the conveyor apparatus of the present invention with respect to traditional conveyor belts. Additionally, the fact that the speed gives inertia to the bagasse thus improving the mill's feed given that it acts as though the shut height were greater. With respect to feed, this is done on the upper portion of the feed drum improving the physical height of the belt by approximately 90 cm, as compared to a conventional chain conveyor, which is fed from below.

Another advantage of the conveyor apparatus of the present invention relates to maintenance given that conventional chain and slat conveyors can cause serious damage, especially if a slat comes loose and is swallowed by the mill. In the first place this would cause a very long halt while the slat is removed. In the second place one of the pieces of the mill could break, for example its carriage, given that the slat is a large piece of metal.

What is desired, then, is a conveying apparatus for sugar mill intermediates that solves the above-listed problems inherent to conventional chain conveyors.

### SUMMARY OF THE INVENTION

An object of the present invention is to provide an apparatus for conveying sugar mill intermediates.

A further object of the present invention is to provide a conveyor belt or belt drive for sugar mill intermediates.

The conveying apparatus for sugar mill intermediates of the present invention allows bagasse exiting a mill to be taken to the entry of the next mill. The present invention is comprised of an industrial type infinite-loop rubber belt outfitted with a number of wings which work as pushers, which are vulcanized to the belt with an internal guide to work with a drive drum. The drive drum is located toward the top part of the belt and consists of a cylinder lined with rubber, which gives greater traction, with a central axle connected to a motor which allows it to move.

The feed drum is located on the opposite or lower end, with a central axis that spins on itself aiding the movement of the belt, and with a runner system that allows the band to be tightened and loosened. The drive drum is mounted on pedestal-type bearings and the feed drum on flange-type bearings. The belt is comprised of four high-resistance canvases. The belt slides over a stainless steel tray located between the two drums, which consist of a rectangular chassis with reinforced fastening structures on each of the two vertexes of its ends. On the upper part of the chassis covering the surface is a stainless steel plate. The tray must be lubricated with water at the lower part of the conveyor at the level of the feed drum in order to reduce the friction between the belt and the stainless steel, reducing wear of the rubber belt and prolonging its useful life.

The conveyor has side or lateral walls that are built of carbon steel and fixed using angles with screws, which prevent the cane bagasse from falling off the conveyor. The conveyor belt has two covers, an upper cover for the drive drum and a lower lid for the feed drum. These prevent material from falling off the conveyor while the bagasse travels over these two areas. There is also a spill duct that allows the material to be deposited in the next mill and also allows the bagasse level to be monitored.

These and other objects and advantages of the invention will become apparent from the following detailed description of the preferred embodiment of the adjustable insulation apparatus.

### BRIEF DESCRIPTION OF THE DRAWINGS

A conveyor apparatus for sugar mill intermediates embodying the features of the present invention is depicted in the accompanying drawings which form a portion of this disclosure and wherein:

FIG. 1 is a side sectional view of the preferred embodiment of the conveyor apparatus of the present invention;

FIG. 2 is an exploded perspective view of the drive drum, feed drum, tray, and belt of the preferred embodiment of the conveyor apparatus of the present invention.

### DESCRIPTION OF THE PREFERRED EMBODIMENT

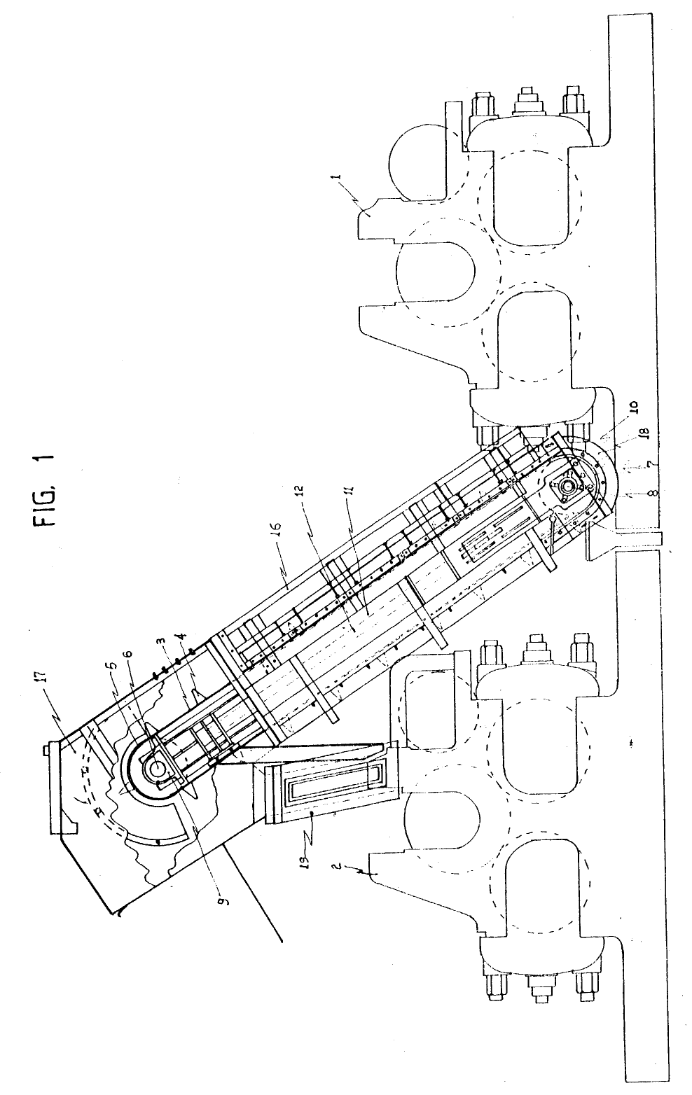

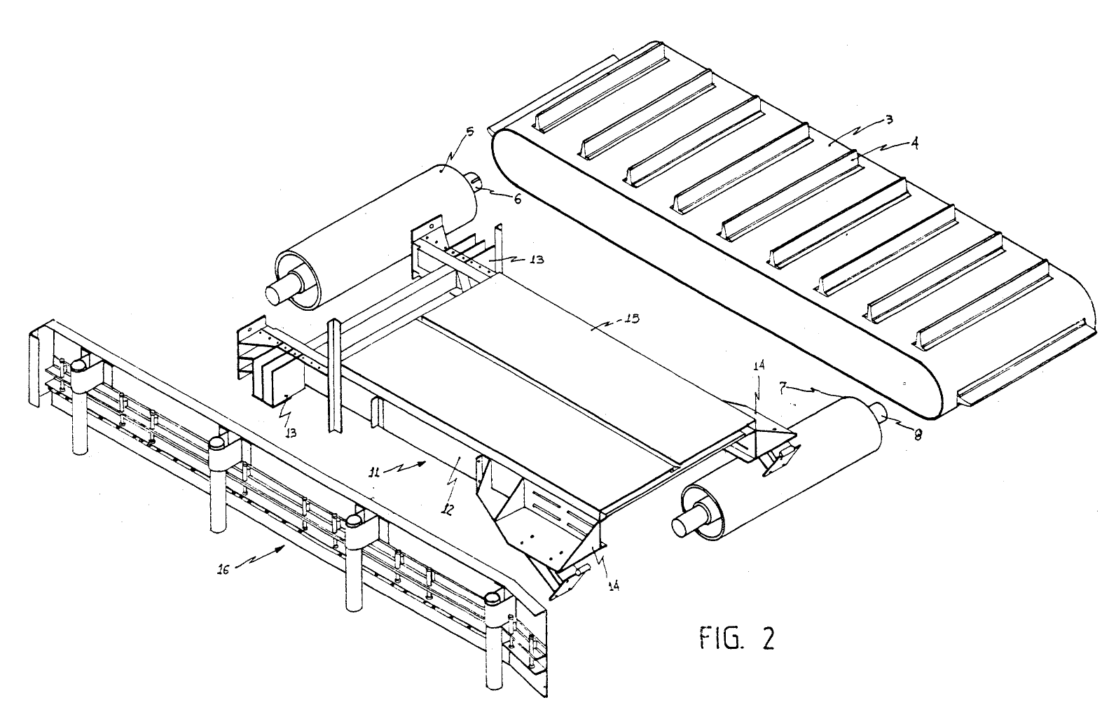

Looking now to FIGS. 1 through 2, the preferred embodiment for the present invention of a conveyor apparatus for sugar mill intermediates is illustrated. FIG. 1 shows a lateral view of the conveyor apparatus with a partial cut in the upper part, which allows the drive drum and part of the belt to be seen. FIG. 2 shows an exploded view of the conveyor apparatus where the drive drum, feed drum, tray, belt and a side or lateral wall can be seen.

The preferred embodiment of the conveyor apparatus covered by the present application allows bagasse exiting mill 1 to be taken to the entry of the next mill 2. This conveyor apparatus is comprised of an industrial type infinite-loop rubber belt 3 outfitted with a number of wings 4 which work as pushers, which are vulcanized to the belt 3 with an internal guide to work with 50.8 cm diameter drive drums. The drive drum 5 is located toward the top part of the belt 3 and consists of a cylinder lined with rubber which gives greater traction, with a central axle 6 connected to a moto-reducer which allows it to move. The feed drum 7 is located on the opposite or lower end, with a central axis 8 that spins on itself aiding the movement of the belt 3, with a runner system that allows the band to be tightened and loosened. The drive drum 5 is mounted on pedestal-type bearings 9 and the feed drum 7 on flange-type bearings 10. This belt 3 is comprised of four high-resistance canvases. The belt 3 slides over a stainless steel tray assembly 11 located between the two drums 5,7, as shown on FIG. 2. The tray assembly 11 comprises a rectangular chassis 12 with reinforced fastening structures 13,14 on each of the two vertexes of its ends. On the upper part of the chassis 12 covering the surface is a stainless steel plate 15. The tray assembly 11 must be lubricated with water at the lower part of the conveyor at the level of the feed drum 7 in order to reduce the friction between the belt 3 and the stainless steel tray assembly 11, reducing wear of the rubber belt 3 and prolonging its useful life. The conveyor apparatus further comprises side or lateral walls 16 that are built of carbon steel and fixed using angles with screws, which prevent the cane bagasse from falling off the conveyor apparatus. The conveyor apparatus has two covers, an upper cover 17 for the drive drum 5 and a lower lid 18 for the feed drum 7, which prevent material from falling off the conveyor apparatus while the bagasse travels over these two areas. There is also a spill duct 19 that allows the material to be deposited in the next mill 2 as well as allowing the bagasse level to be monitored.

Thus, although there have been described particular embodiments of the present invention of a new and useful CONVEYING APPARATUS FOR SUGAR MILL INTERMEDIATES, it is not intended that such references be construed as limitations upon the scope of this invention except as set forth in the following claims.

What is claimed is:

1. Conveyor belt for mill intermediaries characterized by being comprised of an infinite-loop rubber belt (3), a drive drum located toward the upper part of the belt consisting of a rubber lined cylinder and a central axle (6) connected to a moto-reducer that allows it to move. On the opposite or lower end there is a feed drum (7) with a central axle (8) and a runner system that allows the belt to be tightened and loosened. The drive drum is mounted on pedestal-type bearings (9) and the feed drum on flange-type bearings (10). The belt slides over a stainless steel tray (11) located between the two drums. The conveyor has side or lateral walls (16) fixed using angles with screws. It has two covers, an upper cover (17) for the drive drum and a lower cover for the fed drum, and it also has a spill duct (19).

2. A conveyor belt pursuant to claim 1 characterized because the infinite-loop belt is comprised of four pieces of high-resistance canvas and has a series of wings (4) that act as pushers, which are vulcanized to the belt with an internal guide to work with the drive drums.

3. A conveyor belt pursuant to claim 1 characterized because the stainless steel tray (11) located between the two drums consists of a rectangular chassis (12) with reinforced fixing structures (13) and (14) on each of the vertices of its ends and there is a stainless steel plate (15) on the upper part of the chassis covering the surface that encloses its area.

4. An apparatus for conveying sugar mill intermediates comprising:
an infinite-loop rubber belt,
a drive drum in frictional engagement with said belt located toward the upper part of said belt, said drive drum comprising a rubber lined cylinder and a central drive drum axle connected to a motor that allows it to move,
a feed drum in frictional engagement with said belt located toward the lower part of said belt, said feed drum comprising a central feed drum axle and a runner system that allows said belt to be tightened and loosened,
a tray assembly located between said drive drum and said feed drum over which said belt slides,
lateral walls between which said belt slides,
an upper drive cover for said drive drum,
a lower cover for said feed drum, and
a spill duct positioned below said drive drum.

5. The conveying apparatus as described in claim 4 wherein said drive drum is mounted on pedestal-type bearings and said feed drum is mounted on flange-type bearings.

6. The conveying apparatus as described in claim 5 wherein said tray assembly is comprised of stainless steel.

7. The conveying apparatus as described in claim 4 wherein said belt further comprises a series of wings that act as pushers.

8. The conveying apparatus as described in claim 7 wherein said wings are vulcanized to said belt with an internal guide to work with said drive drum and said feed drum.

9. The conveying apparatus as described in claim 4 wherein said belt is comprised of four pieces of high-resistance canvas.

10. The conveying apparatus as described in claim 4 wherein said tray assembly comprises a rectangular chassis having two ends, said tray assembly further comprising reinforced fixing structures on each of said two ends at the vertices thereof, said chassis having an upper part, and a stainless steel plate on said upper part of said chassis covering the surface that encloses its area.
